(19) United States
(12) Patent Application Publication
(10) Pub. No.: US 2010/0150131 A1
(43) Pub. Date: Jun. 17, 2010

(54) SIGNALING PARAMETERS CHANNEL PROCESSING

(75) Inventors: Krishna Kiran Mukkavilli, San Diego, CA (US); Ashok Mantravadi, San Diego, CA (US); Durk L. van Veen, Santee, CA (US); Murali Ramaswamy Chari, San Diego, CA (US); Raghuraman Krishnamoorthi, San Diego, CA (US); Rajeev Krishnamurthi, San Diego, CA (US); Fuyun Ling, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/509,820

(22) Filed: Jul. 27, 2009

Related U.S. Application Data
(63) Continuation-in-part of application No. 12/334,436, filed on Dec. 12, 2008.

(51) Int. Cl. H04J 3/00; H04J 3/06

(52) U.S. Cl. 370/350; 370/345

(57) ABSTRACT

In a multicasts wireless telecommunication system providing an aggregation of one or more independent data components as a flow, wherein the OIS is located at the latch point of the beginning of the superframe, and the OIS programming is latched at the superframe boundary, the improvement of deriving signal parameter information from Signaling Parameter Channel (SPC) symbols transmitted in a Forward Link only (FLO) network by deriving a time domain channel estimate by assuming each of the combinations for the signal parameter field in the scrambler seed and picking the signal parameter combination that yields the most energy in the time domain above a threshold value.

This application in a Continuation-in-Part of U.S. Ser. No. 12/334,436, filed Dec. 12, 2008, entitled “SIGNALING PARAMETERS CHANNEL PROCESSING.”

Claim of priority Under 35 USC §120

The present application for a patent claims priority to utility application Ser. No. 12/334,436, entitled “SIGNALING PARAMETERS CHANNEL PROCESSING” filed Dec. 12, 2008, and assigned to the assignee hereof and hereby expressly incorporated by reference herein.

### BACKGROUND

1. Field

The present disclosed embodiments relates generally to processing wave forms in a wireless telecommunication system at the Forward Link Only (FLO) receiver, and more specifically to signaling parameters channel (SPC) and its associated processing at the FLO receiver, wherein SPC is a new channel added to the FLO superframe as a revision of the FLO air interface specification to convey physical layer parameters that cannot be transmitted through the Overhead Information Symbol (OIS).

2. Background

The Forward Link Only (FLO) system multicasts several services. A service is an aggregation of one or more independent data components. Each independent data component of a service is called a flow. For example, a flow can be the video component, audio component, text or signaling component of a service.

The transmitted signal in the Forward Link Only system is organized into superframes, wherein each superframe has the duration of about one second. FIG. 1 shows the general relationship (not to scale) between the various physical layer channels in a superframe, such as the OIS and the data channels.

Forward Link Only services are carried over one or more logical channels, and these logical channels are called Multicast Logical Channels or MLCs. It is the smallest addressable element in the FLO Network transmission system.

The definition of the FLO Air interface is that the FLO physical layer consists of the FLO physical layer channels. The OIS and Data are two of them. OIS stands for overhead information symbol channel. OIS channel carries the important system information sent out by the network.

However, there are physical layer parameters in the FLO superframe that cannot be transmitted through the OIS.

There is therefore a need in the wireless telecommunications systems devices employing the Forward Link Only (FLO) system multicast services to acquire physical layer parameters that cannot be transmitted through the OIS.

### SUMMARY

Embodiments disclosed herein address the above stated needs to convey physical layer parameters by employing Signaling Parameter Channel in associated processing at the FLO receiver, so that the SPC when added to the FLO superframe enables physical layer parameters that cannot be transmitted through the OIS to now be conveyed.

In one aspect of the SPC addition to the FLO superframe, the SPC carries information that would be required to decode the OIS itself.

In another aspect, since one important characteristic of SPC is that the SPC wave form is independent of the physical layer parameters such as slot to interlace map, the Fast Fourier Transform (FFT) and cyclic prefix, this allows the receiver to be able to decode the information carried by the SPC under any network deployment conditions using default factory settings. The information obtained from the SPC can then be used to decode the OIS, which in turn will allow for other parameters to be configured via the network.

In yet another aspect, the SPC symbols have been designed such that the receiver processing is along the lines of Wide Area Differentiator/Local Area Differentiator (WID/LID) determination in the WIC/LIC symbols allow reuse of hardware in the receiver.

### BRIEF DESCRIPTION OF DRAWINGS

FIG. 1 depicts the location and relationship of the OIS channel and data channel in the FLO (Forward Link Only) superframe structure.

FIG. 2 shows the superframe structure for FLO with PPC symbols and SPC symbols which are always of duration 4625 chips.

FIG. 3 shows a SPC symbol structure.

FIG. 4 shows a block diagram for SPC processing at the receiver.

FIG. 5 is a diagram of a hardware circuit to implement the descrambling operation.

FIG. 6 is a block diagram for the threshold operation.

### DETAILED DESCRIPTION

Signalling parameters Channel (SPC) and its associated processing at the FLO receiver is a new channel that is added to FLO superframe in revision of the FLO Air Interface Specification. In particular, SPC is added to the FLO superframe to convey physical layer parameters that cannot be transmitted through the OIS. For example, SPC carriers information that would be required to decode the OIS itself. The information that is carried by the SPC includes FFT mode information (1k, 2k, 4k, 8k), the cyclic prefix length used ( 1/16. ⅛, ¼ or ⅜) and the slot to interlace map used ((2,6) pattern, (0,3,6) pattern).

Each SPC symbol can convey 8 bits of information. Therefore, 16 bits of information can be conveyed using the two SPC symbols. 16 bits of information allows for additional room to convey any other information that may be required in the future.

One important characteristic of SPC is that the SPC waveform is independent of the physical layer parameters such as slot to interlace map, FFT mode and cyclic prefix. This allows the receiver to be able to decode the information carried by SPC under any network deployment conditions using default factory settings. The information obtained from the SPC can then be used to decode OIS, which will in turn allow for other parameters to be configured via network. SPC symbols have been designed such that the receiver processing is along the lines of WID/LID determination in WIC/LIC symbols or the (Positioning Pilot Channel) PPC symbol to simplify the receiver architecture. While SPC waveform conveys the FFT mode information also in addition to other physical layer parameters, it may be possible for the device to acquire the FFT mode information by other means. For instance, the device may perform hypothesis testing on the FFT modes by detecting the TDM1 symbols by matching to the waveform transmitted for each of the FFT modes. In this case, the FFT information may already be available and the SPC symbols may be used to acquire cyclic prefix length and the slot to interlace information. On the other hand, another implementation is possible where TDM1 detection does not yield the FFT mode information. For instance, the minimum periodicity across all the FFT modes can be used to perform delayed correlation on the TDM1 symbols and the resulting ambiguity in the FFT size than can then be resolved using the SPC symbols. In either case, the manner of processing the SPC symbols may not be different.

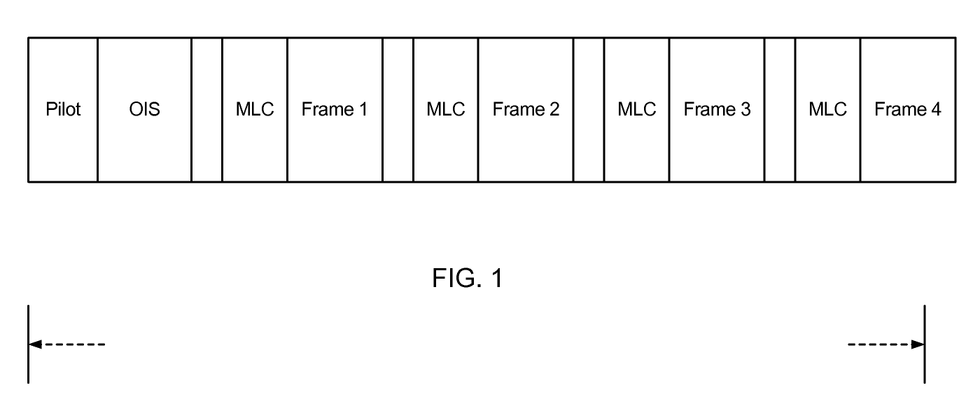

With regard to the numerology of the innovation, SPC symbols occur at the end of FLO superframe. SPC symbols are always two in number, and this fixed numerology follows across all modes of transmission. The superframe structure for FLO with PPC symbols and SPC symbols is shown in FIG. 1 SPC symbols are always of duration 4625 chips and have identical structure across FFT modes, cyclic prefix lengths and pilot patterns. It should be noted that SPC symbol structure is described in terms of 4K mode interlaces and does not depend on the FFT mode used for the rest of the superframe.

See FIG. 1 which shows the location and relationship of the OIS channel and data channel in the forward link only (FLO) air interface by way of the super frame structure. The FLO transmitted signal is organized into super frames, wherein each super frame is comprised of four frames of data, including the TDM pilots, the overhead information symbols (OIS) and frames containing wide-area and local-area data. In general, each super frame consists of 200 OFDM symbols per MHz of allocated bandwidth (1200 symbols of 6 MHz), and each symbol contains 7 interlaces of active subcarriers. Each interlace is uniformly distributed in frequency, so that it achieves the full frequency diversity within the available bandwidth. These interlaces are assigned to logical channels that vary in terms of duration and number of actual interlaces used to provide flexibility in the time diversity achieved by any given data source. Lower data rate channels can be assigned fewer interlaces to provide time diversity, while higher data rate channels utilize more interlaces to minimize the signal on-time and reduce power consumption. The acquisition time for both low and high data rate channels is approximately the same. Both frequency and time diversity can be maintained without compromising acquisition time.

SPC symbols are recovered using the demodulation technique that is based on matching the descrambling sequence with the scrambling sequence. In particular, useful information from the received signal can be obtained only when the scrambling sequence at the receiver is matched to the scrambling sequence used at the transmitter. If the scrambling sequence is mismatched, then the received signal would appear as noise to the receiver. However, if the scrambling sequence used at the receiver matches with the transmitted sequence, then the receiver would be able to extract information from the received signal. In particular, SPC symbol transmits pilots in the frequency domain on interlaces 0 and 4 with the only unknown at the receiver being the four bits used in the scrambler seed for each of the interlaces. The algorithm used for SPC decoding computes the channel estimate in time domain using the pilots from each of the interlaces and also a particular combination of the four unknown bits in the scrambler seed. When the receiver scrambler seed is not matched to the transmitter, the time domain channel estimate appears noisy with no significant energy taps. However, when the receiver scrambler seed matches with that of the transmitter, the time domain channel estimate will exhibit energy concentrated in few taps. In order to identify the concentration of the energy in few taps, an energy threshold is set and the energy above the threshold is collected for each of the hypotheses. The four bits in the SPC information field of the scrambler seed index corresponding to the maximum energy are declared as the Information bits contained in that particular SPC symbol interlace.

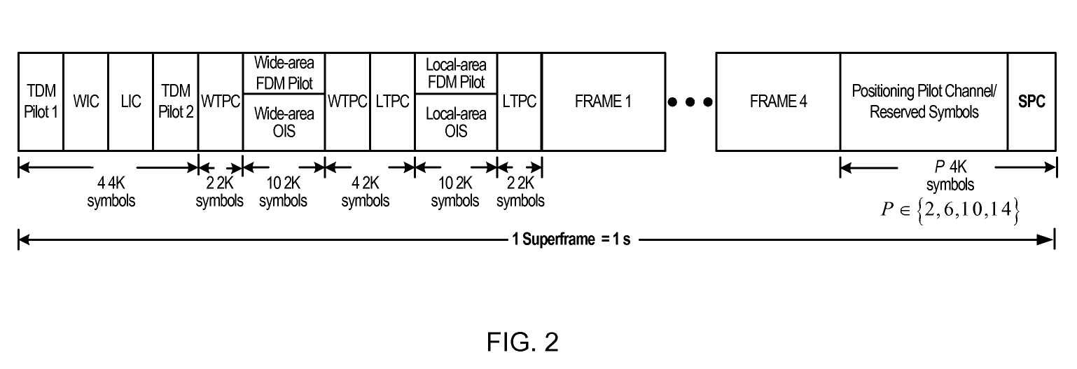

Reference is now made to FIG. 2, which shows the superframe structure for the FLO with the SPC and PPC symbols. As can be seen from FIG. 2, the SPC symbols are at the end of the FLO superframe. The SPC symbols are always two in number, and follow fixed numerology across all modes of transmission. The SPC symbols are always of duration 4625 chips. The break up of the SPC symbols is independent on the FFT mode. In this connection, it should be noted that the SPC symbols structure is based on 4K mode interlaces and does not depend on the FFT mode used for the rest of the superframe.

The superframe structure for the FLO waveform with SPC and PPC symbols is shown in FIG. 2, and the numerology for the two SPC symbols is as follows:

FFT window=4096 chips

Cyclic prefix=512 chips

Window=17 chips

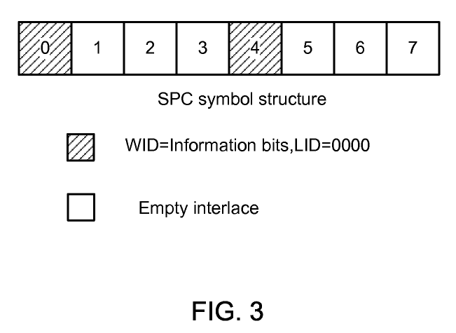

As can be seen from the SPC symbol structure of FIG. 3, there are two 4K mode interlaces active in each SPC symbol. In particular, interlaces 0 and 4 are occupied in the frequency domain. Two active interlaces in the frequency domain lead to a time domain waveform that is periodic with a periodicity of 1024 samples, and four such periods occur within the FFT window. Information in SPC symbols is conveyed through the scrambler seed used for interlaces 0 and 4. Specifically, the SPC information field in the scrambler seed is used to convey 4 bits of information in each interlace. The scrambler seed referred to here is the 20 bit scrambler seed specified in FLO AIS given by

d3d2d1d0 c3c2c1c0 b0 a10a9a8a7a6a5a4a3a2a1a0
where
a10a9a8a7a6a5a4a3a2a1a0 —correspond to the OFDM symbol index
b0—reserved bit set equal to 1
c3c2c1c0—set to 0000
d3d2d1d0—SPC information field. The receiver should use the following information for descrambling the SPC symbols.
In addition to the scrambler seed, the mask used for scrambling is based on the slot information. The information for each of the interlaces in SPC0 and SPC1 is as follows (see FIG. 3).

### Interlace 0:

Symbol index (a10-a0)—hard coded: SPC0=0, SPC1=1
SPC information field=4 bits of Information to be conveyed
Slot index=0 (identity slot to interlace map used)

### Interlace 4:

Symbol index (a10-a0)—hard coded: SPC0=0, SPC1=1
SPC information field=4 bits of Information to be conveyed
Slot index=4 (identity slot to interlace map used)
Symbol index (a10-a0)—hard coded: SPC0=0, SPC1=1

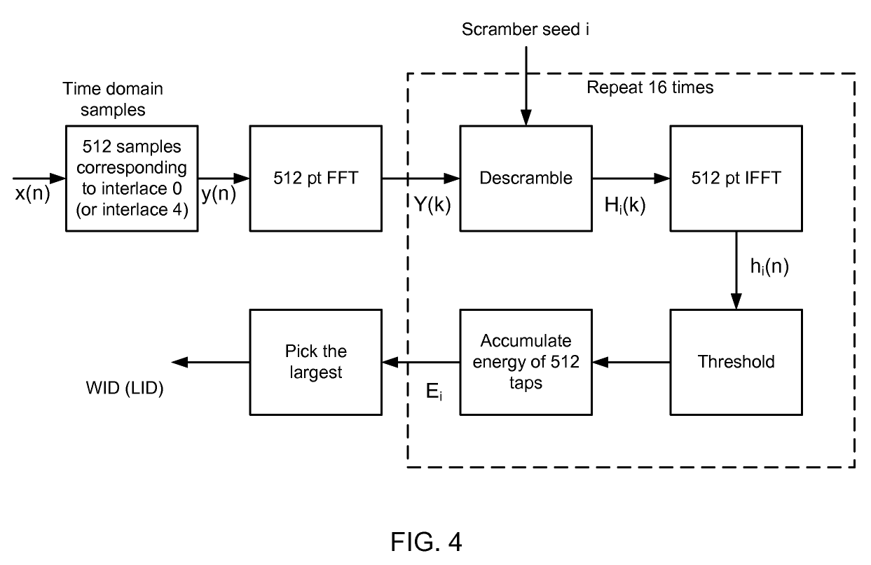

The block diagram for SPC processing is shown in FIG. 4, where the software collects the 16 bits of information obtained from SPC0 and SPC1 and determines the system parameters to be used for decoding the FLO waveform. Based on the decoded information, the software programs the slot to interlace map to be used, the cyclic prefix information and the FFT mode information to be used by the hardware to decode the OIS and data channels in the superframe.

The steps involved in determining the scrambler information is described in the following sections. While the processing for interlace 4 is almost identical to that of interlace 0, there are a few minor differences which will be highlighted wherever they occur.

Scrambler Seed Detection.

The receiver operations involved in scrambler seed detection corresponding to all the fields other than the SPC information field are known at the receiver. Also, to distinguish between the four SPC information fields detected during the processing of the two SPC symbols, we refer to the four fields as SPC00, SPC04, SPC10,SPC14, where the first index after SPC refers to SPC symbol index and the second index corresponds to interlace index. SPC processing is typically initiated in HW by an associated software. This enables the processing of one or both the SPC symbols in the superframe.

Time Domain Interlace

SPC symbol processing follows TDM1 detection in the superframe. WIC/LIC detection and TDM2 processing may also be done following TDM1 depending on the methods used to detect TDM1. In any case, the close to 1 second delay between processing TDM1 and SPC symbols could potentially result in timing drifts, thus resulting in possible ambiguity in symbol boundary at SPC. Therefore, we use only two periods (2K samples) out of the total of four possible periods (4K samples) in the SPC symbol. Note that depending on the timing ambiguity expected from the circuitry of the chip, one to four periods of the SPC waveform can be used for processing. The start of the window for collecting the 2K samples may be programmable by software through a register FLO_SPC_OFFSET, for example.

During each SPC symbol, the FFT block collects 2K samples starting at sample number FLO_SPC_OFFSET coming out of the AFC. FFT extends the 2K samples periodically to form 4K samples (2 periods of 2K samples). Let x(n),n=0,1.4095 be the 4096 samples after periodic extension where x(n)=x(n+2048), for 0≦n≦2047. FFT block forms 512 time domain interlace samples corresponding to interlace 0 and interlace 4 using x(n), n=0,1 . . . 4095. Let the 512 samples corresponding to interlace m be denoted by yₘ (n), n=0,1,2, . . . 511, where m=0,4.

512 pt FFT

The next step in computing WID is to perform a 512 pt FFT on the sequence {yₘ(n)} corresponding to interlaces 0 and 4. The 512 pt FFT (with normalization as implemented in the hardware) is given by

$${Y}_{m} ( k ) = \frac{1}{64} {\sum }_{l = 0}^{511} {y}_{m} ( l ) {e}^{\frac{- j 2 π lk}{512}} , for k = 0 , 1 , 2 , … 511.$$

At the output of the FFT block, the samples corresponding to interlaces 0 and 4 given by {Yₘ(k)}, k=0,1,2 . . . 511 in frequency domain where each frequency domain sample is a complex number.

Descrambling

After obtaining the frequency domain samples, hypothesis testing is performed using the 16 possible scrambler seeds corresponding to the 4 bits for the SPC information field in the scrambler seed for each of the two interlaces. The scrambler seed and mask parameters for the interlace 0 and interlace 4 are as follows:

### Interlace 0:

Symbol index=0000 for SPC0 and 0001 for SPC1

SPC information field=all combinations from 0000 through 1111

Slot index=0 (since identity slot to interlace map is used)

Interlace 4

Symbol index=0000 for SPC0 and 0001 for SPC1

SPC information field=all combinations from 0000 through 1111

Slot index=4 (identity slot to interlace map)

If the scrambler output corresponding to the k th subcarrier in the interlace 0 corresponding to the i th hypothesis (i goes from 0 through 15) is given by Sᵢ (k), then the descrambler output is given by:

Hᵢ(k)=Y(k)Sᵢ*(k)

Note that Sᵢ, (k) is obtained by mapping the scrambler output [b₂ₖ b₂ₖ₊₁] to the QPSK constellation. Multiplication by Sᵢ*(k) is accomplished as a clockwise rotation by a multiple of π/2 as shown in Table 1 followed by a clockwise rotation by π/4 (given by 1-j ignoring scaling by

$$\frac{1}{\sqrt{2}} ) .$$

TABLE 1

| (b₂ₖ₊₁ b₂ₖ) (from scrambler) | Angle of rotation (degrees) |
|---|---|
| 00 | 0 |
| 01 | 90 |
| 11 | 180 |
| 10 | 270 |

### Descrambling Operation Based on the Scrambler Output

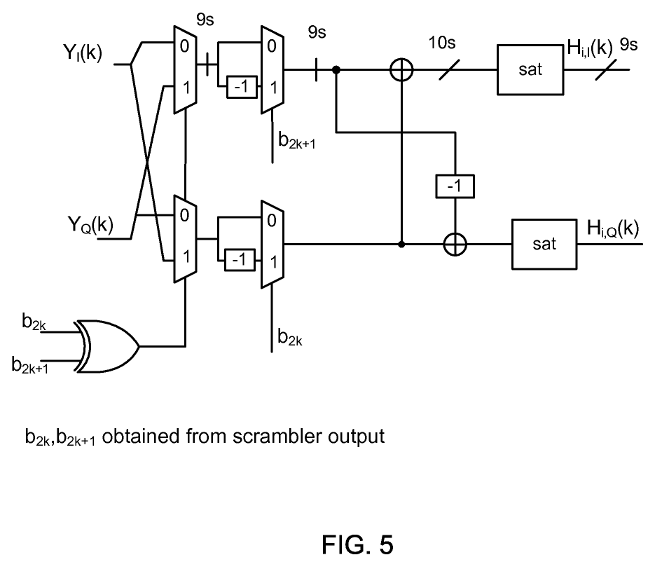

The hardware operations for descrambling is the same as that used for descrambling of the pilot symbols in channel estimation, WIC/LIC symbols and PPC acquisition mode operations, and the hardware circuit to implement the descrambling operation is shown in FIG. 5.

Zero Extrapolation

Note that there are only 500 pilots transmitted in each of the active interlaces for the SPC symbols. A least squares channel estimate based on 500 pilots would involve a matrix inversion operation and is computationally expensive. Therefore, it is computationally advantageous to extend the 500 pilot observations to 512 observations so that the least squares channel estimation operation can be reduced to a 512 point IFFT operation. The extension of 500 pilot observations to 512 observations can be done in one of several ways. One way to extend the observations is to use zero extrapolation where the missing pilot observations are replaced with zeros. The zero extrapolation performed on Hᵢ(k) is similar to the zero extrapolation performed during channel estimation. The memory locations are zeroed out are slightly different between interlaces 0 and 4.

For Interlace 0: set the memory locations between 251 and 261 (11 subcarriers) in the buffer corresponding to Hᵢ(k)'s equal to zero to account for the presence of guard subcarriers. In addition, the DC subcarrier at memory location 0 should also be set to zero.

For Interlace 4: set the memory locations between 250 and 261 (12 subcarriers) in the buffer corresponding to Hᵢ(k)'s equal to zero to account for the presence of guard subcarriers. In this case, DC subcarrier is not part of the interlace and hence does not require special attention.

Another example of extrapolation is a zero order hold where the last pilot observation is extended to fill in the missing pilots. In yet another case, the missing pilot observations may be formed by a filtering process on all the available pilot observations.

After extrapolation, we obtain 512 values for Hᵢ(k). We then perform a 512 pt IFFT operation on the extrapolated values for WID hypothesis i to obtain the corresponding time domain samples. The IFFT operation on the extrapolated values Hᵢ(k) is given by (with normalization as in the hardware)

$${h}_{i} ( l ) = \frac{1}{64} {\sum }_{k = 0}^{511} {H}_{i} ( k ) {e}^{\frac{j 2 π lk}{512}} , for l = 0 , 1 , 2 … 511.$$

At the output of the IFFT operation, we obtained a 512 length time domain channel estimate given by {hᵢ(l)} corresponding to the transmitter using the scrambling pattern with the WID given by index i. Each time domain sample is a complex number with the real and imaginary parts represented by 9 bits. The next step is to threshold the channel estimate to remove contribution of noise and measure energy against each hypothesis.

Thresholding and Energy Measurement

After obtaining the time domain channel estimate, the energy in each tap is computed and compared to a threshold value. The thresholding and energy measurement procedure is similar to that in WIC/LIC and PPC processing. The threshold value to be used is programmed by software in FLO_SPC_THRESHOLD, which is referred to as β.

For each hypothesis i, the pseudo code for measuring the corresponding energy Eᵢ is as follows:

```
Eᵢ = 0;
for l = 0..511
  if |hᵢ(l)|² ≧ β
    Eᵢ = Eᵢ + |hᵢ(l)|²;
  end;
end;
```

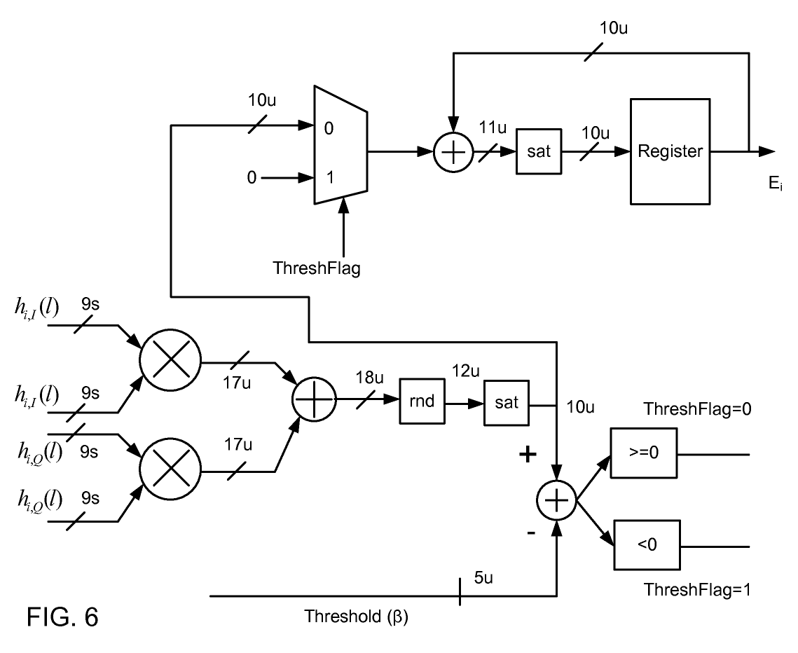

The block diagram for implementing the thresholding operation and energy accumulation is given in FIG. 6.

The above steps corresponding to descrambling through thresholding and energy measurement are repeated for all of the 16 hypotheses. After collecting energies Eᵢ for i=0, 1, . . . 15 corresponding to the 16 hypotheses, we find i for which Eᵢ is maximum. The four bits representing the winning hypothesis which is the value of corresponding to maximum Eᵢ represent the information contained in that particular interlace of the SPC symbol. The same process is repeated independently on each of the two interlaces and then on each of the SPC symbols in the superframe.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A method to process TDM symbols carrying information about signaling parameters used for generating the waveform in a wireless broadcast network.

2. The method of claim 1 where the wireless broadcast network is Forward Link Only (FLO) network.

3. The method of claim 1 where the signaling parameters are specific to an OFDM system such as FFT size, cyclic prefix length and pilot stagger pattern.

4. The method of claim 1 where the TDM symbols refer to the symbols comprising the Signaling Parameter Channel (SPC) in a Forward Link Only (FLO) network.

5. The method of claim 1 where processing the TDM symbols involves deriving signal parameter information from Signaling Parameter Channel (SPC) symbols transmitted in a Forward Link only (FLO) network by deriving a time domain channel estimate by assuming each of the combinations for the signal parameter field in the scrambler seed and picking the signal parameter combination that yields the most energy in the time domain above a threshold value.

6. The process of claim 5, wherein the time domain channel estimate is obtained by:
a. collecting one or more periods of the SPC samples in the domain;
b. performing an FFT on the collected time domain samples in a) to obtain the corresponding frequency domain pilot samples;
c. selecting one of several possibilities for the signal parameter information in the scrambler seed and descrambling the frequency domain pilot samples obtained in b);
d. performing extrapolation in the frequency domain to extend the pilot observations so that the total number of observations is a power of 512;
e. performing a 512 point IFFT operation on the extrapolated frequency domain samples obtained in d) to get a time domain channel estimate corresponding to the selected scrambler seed;
f. selecting an energy threshold and computing the sum of the energy of all the time domain channel taps that exceed the threshold;
g. repeating steps c) through f) with all possible combinations of the signal parameter field in the scrambler seed; and
h. determining the signal parameter combination that results in the maximum energy in g) as the transmitted signal parameter information.

7. The process of claim 5, wherein the time domain samples corresponding to the SPC symbols are identified in the superframe by selecting a factory default combination of the FFT, CP and pilot pattern for synchronizing with the superframe.

8. The process of claim 6, wherein all the steps are repeated for interlaces 0 and 4 in both the SPC symbols.

9. The process of claim 6, wherein the energy threshold in steps f) is precomputed.

10. The process of claim 6, wherein the energy threshold in steps f) is based on the maximum energy tap derived in step e).

11. The process of claim 6, wherein the time domain channel estimate in e) is obtained as a least squares estimate from the frequency domain pilot observations in c).

12. The process of claim 6, wherein the extrapolation in d) is performed using zero extrapolation, zero order hold or a filtering operation on all the pilot observations.

13. In a multicasts wireless telecommunication apparatus providing an aggregate of one or more independent data components as a flow, wherein the OIS is located at the latch point of the beginning of the superframe, and the OIS programming is latched at the superframe boundary, the apparatus improvement of:
means for deriving signal parameter information from Signaling Parameter Channel (SPC) symbols transmitted in a Forward Links only (FLO) network, comprising means for deriving a time domain channel estimate that selects each of the combinations for the signal parameter field in the scrambler seed; and means for picking the signal parameter combination that yields the most energy in the time domain above a threshold value.

14. The multicast wireless telecommunication apparatus of claim 13, comprising:
a) means for collecting one or more periods of the SPC samples in the time domain;
b) means for performing an FFT on the collected time domain samples in a) to obtain the corresponding frequency domain pilot samples;
c) means for selecting one of several possibilities for the signal parameter information in the scrambler seed for descrambling the frequency domain pilot samples obtained in b);
d) means for performing extrapolation in the frequency domain to extend the pilot observation's so that the total number of observations is a power of 512;
e) means for performing a 512 point IFFT operation on the extrapolated frequency domain samples obtained in d) to get a time domain channel estimate corresponding to the selected scramble seed; and
f) means for selecting an energy threshold and computing the sum of the energy of all the time domain channel taps that exceed the threshold.

15. The multicast telecommunication apparatus of claim 13 further comprising means for selecting a factory default combination of the FFT, CP and pilot pattern for synchronizing with the superframe to provide the time domain samples corresponding to the SPC symbols identified in the superframe.

16. The multicast telecommunication apparatus of claim 14 further comprising means to repeat all of the steps for interlaces 0 and 4 in both the SPC symbols.

17. The multicast telecommunication apparatus of claim 14, further comprising means to precompute the energy threshold in step f).

18. The multicast telecommunication apparatus of claim 14, further comprising means to precompute the energy threshold in step f) based on the maximum energy tap derived in step e).

19. The multicast telecommunication apparatus of claim 14, further comprising means to obtain the time domain channel estimate in e) as a least squares estimate from the frequency domain pilot observations in step c).

20. The multicast telecommunication apparatus of claim 14, further comprising means to perform the extrapolation in d) using zero extrapolation or zero order hold or a filtering operation on all of apparatus the pilot observations.

21. A computer-readable medium comprising instructions which, when executed by the machine, cause the machine to perform operations including:
deriving signal parameter information from Signaling Parameter Channel (SPC) symbols transmitted in a Forward Link only (FLO) network by deriving a time domain channel estimate by assuming each of the combinations for the signal parameter field in the scrambler seed and picking the signal parameter combination that yields the most energy in the time domain above a threshold value.

22. A computer-readable medium comprising instructions which, when executed by the machine, cause the machine to perform operations including:
a) collecting one or more periods of the SPC samples in the domain;
b) performing an FFT on the collected time domain samples in a) to obtain the corresponding frequency domain pilot samples;
c) selecting one of several possibilities for the signal parameter information in the scrambler seed and descrambling the frequency domain pilot samples obtained in b);
d) performing extrapolation in the frequency domain to extend the pilot observations so that the total number of observations is a power of 512;
e) performing a 512 point IFFT operation on the extrapolated frequency domain samples obtained in d) to get a time domain channel estimate corresponding to the selected scrambler seed;
f) selecting an energy threshold and computing the sum of the energy of all the time domain channel taps that exceed the threshold;
g) repeating steps c) through f) with all possible combinations of the signal parameter field in the scrambler seed; and
h) determining the signal parameter combination that results in the maximum energy in g) as the transmitted signal parameter information.
